(19) United States
(12) Patent Application Publication
(10) Pub. No.: US 2014/0327919 A1
(43) Pub. Date: Nov. 6, 2014

(54) Remote Seal for Pressure Sensor

(71) Applicant: HALLIBURTON ENERGY SERVICES. INC., Houston, TX (US)

(72) Inventors: Mikko Jaaskelainen, Katy, TX (US); William N. Gibler, Tomball, TX (US); Ian B. Mitchell, Katy, TX (US)

(73) Assignee: Halliburton Energy Services. Inc., Houston, TX (US)

(21) Appl. No.: 13/887,770

(22) Filed: May 6, 2013

(51) Int. Cl. G01L 9/00

(52) U.S. Cl. CPC G01L 9/0079
USPC 356/480

(57) ABSTRACT

A system for sensing downhole pressure in in a hydrocarbon well using a Fabry-Perot (F-P) sensor in series with a Fiber Bragg Grating and maintaining the back pressure on the sensor system with a surface sealing system and a surface pressure control system.

### CROSS-REFERENCE TO RELATED APPLICATIONS

Not applicable.

### BACKGROUND

High-performance measurement on static and dynamic pressure is extremely important in many industrial areas, such as petrochemical industry, fluid engineering, wind tunnel test, biomedicine, and industrial safety. For example, reliable pressure measurement of the underground oil reservoir can provide key data that can be used to determine the quantity of oil reserve and to optimize the production rates of reservoir recovery.

The growing consumption of oil globally has led to an increasing need to produce oil in more and more hostile environments. These environments result from the increasing application of offshore drilling, increasing production from heavy and viscous sources, and extended high temperature horizontal drilling. Continuous reliable downhole pressure measurements in wells could provide key data that can permit better, faster reservoir characterization and improving forecasting of reservoir capability, thereby permit operators to optimize the recovery of reserves.

Fiber-optic sensors have been demonstrated to be especially attractive for the measurement of a wide variety of physical and chemical parameters in harsh environments. In comparison with conventional sensors, fiber-optic sensors own many advantages, such as immunity to EMI, small size, light weight, resistance to chemical corrosion, high accuracy, resolution, and capability of remote operation.

The extrinsic Fabry-Perot interferometer (EFPI) based fiber-optic sensor has been developed as a pressure sensor and experienced increasing use due to the advantages of smaller size, immunity to the polarization-induced fading, and extremely high sensitivity. In particular diaphragm based EFPI sensors have grown in use due to their ability to better sense dynamic and low-pressure variations. In one variant of this type of pressure sensor a Fabry-Perot sensor is combined with a Fiber Bragg Grating in series for temperature compensation. Accurate pressure readings require that the pressure inside the cavity is known and well defined. Adding a pressure barrier on the back-end of the gauge cavity does this, and the gauge cavity is then evacuated during gauge manufacturing so that a low pressure close to vacuum has been achieved. This will then allow the gauge to measure absolute pressure (psia).

This type of gauge then requires a robust back-end seal to maintain the pressure barrier. At more “normal” operating temperatures (<175 C) these types of seals can be maintained. But the more hostile environments now being encountered sometimes result in operations near 300 C and much greater difficulty in maintaining a seal.

There is a growing need for the improved systems for dealing with the maintaining the pressure seal for these sophisticated sensor systems.

### BRIEF DESCRIPTION OF THE DRAWINGS

FIG. 1 illustrates a proposed system for addressing the needs described in this disclosure.

### DETAILED DESCRIPTION

In the following detailed description, reference is made that illustrate embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims.

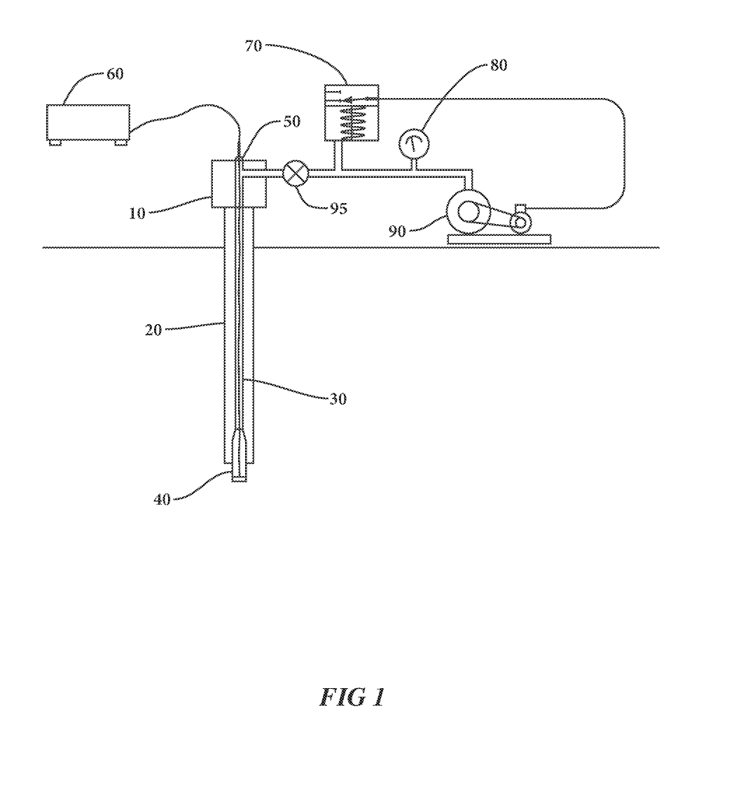

FIG. 1 illustrates a combination of elements of this disclosure, including both the surface and subsurface elements. These include at least a down-hole fiber optic gauge 40 in a subsurface well 20, at least one optical fiber 25 deployed in at least one conduit 30 in that well, where the optical fiber is connecting the fiber optic gauge 40 with surface instrumentation 60, a pressure seal 50 at the back-end of the gauge and above the ground surface to maintain a known reference pressure inside the gauge 40, associated hardware to make enable a known and accurate reference pressure.

Pressure gauge 40 is based on a Fabry-Perot (F-P) sensor with a FBG for temperature compensation. The Fabry-Perot pressure gauge has a membrane with the outside of the membrane exposed to the environment where we desire to measure the pressure. The inside of the membrane has a reflective surface and forms one side of the Fabry-Perot cavity, and the size of the Fabry-Perot cavity changes as the membranes flex due to varying pressure. In this approach proposed herein the pressure back-end seal maintaining the back pressure on the sensor assembly is not subsurface but on the surface and not exposed to the harsh subsurface temperatures.

In addition, also on the surface, a controlled pressure system connected to the conduit below the back-end pressure seal 50 via a valve 95, and comprising a vacuum source 90, a vacuum gauge 80, and a vacuum controller system 70 that controls the vacuum source are used to maintain a known and well defined back end gauge pressure close to full vacuum, (i.e., near 0 psia). The vacuum controller system could be as simple as an on/off switch with narrow set points or could be a more sophisticated PID control system. The vacuum source can be a conventional vacuum pump or any other vacuum source that might be available at a subsurface well site. Valve 95 can be used to isolate the controlled pressure system once a reliable seal is established and a known low pressure is established. In an embodiment the controlled pressure system could then be removed and used on another subsurface well.

In an alternate embodiment, once the vacuum is well established the vacuum source can be disconnected with a known low pressure in place.

The majority of subsurface pressure gauges today operate at temperatures below 175° C., and there are well known techniques to make a working back-end seal. The current gauge design targets applications up to 300° C., and the commonly used techniques to create pressure barriers doesn't work, are impractical or cost-prohibitive due to the seal manufacturing process. The proposed solution to this problem can maintain a conduit pressure of 0.1 psi or less (achievable with commercially available vacuum systems) and result in a maximum error of 0.1 psi or less, sufficient for gauge operation.

Although certain embodiments and their advantages have been described herein in detail, it should be understood that various changes, substitutions and alterations could be made without departing from the coverage as defined by the appended claims. Moreover, the potential applications of the disclosed techniques is not intended to be limited to the particular embodiments of the processes, machines, manufactures, means, methods and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized. Accordingly, the appended claims are intended to include within their scope such processes, machines, manufactures, means, methods or steps.

What is claimed is:

1. A system for sensing downhole pressure in in a subsurface well, comprising:
a. at least one downhole fiber optic gauge;
b. at least one tubular conduit deployed from the surface and connected to said fiber optic gauge;
c. at least one optical fiber deployed within said at least one tubular conduit from the surface to the fiber optic gauge; and
d. a back-end pressure seal at the surface for maintaining a seal between the at least one tubular conduit and the at least one optical fiber exiting the conduit at the surface.

2. The system for sensing downhole pressure in in a subsurface well of claim 1 wherein the said at least one downhole fiber optic gauge is an extrinsic Fabry-Perot (F-P) sensor in series with a Fiber Bragg Grating for temperature compensation.

3. The system for sensing downhole pressure in in a subsurface well of claim 1 wherein a surface pressure control system is connected to the at least one tubular conduit below the back-end pressure seal.

4. The system for sensing downhole pressure in in a subsurface well of claim 3 wherein the surface pressure control system comprises:
a. a vacuum source;
b. a vacuum gauge for monitoring the pressure in the surface pressure control system; and
c. a vacuum controller system for controlling the operation of the vacuum source.

5. A method for sensing downhole pressure in a subsurface well, comprising:
a. deploying at least one downhole fiber optic gauge in the hydrocarbon well;
b. providing at least one tubular conduit deployed from the surface and connected to said fiber optic gauge;
c. providing at least one optical fiber deployed within said at least one tubular conduit from the surface to the fiber optic gauge; and
d. providing a back-end pressure seal at the surface for maintaining a seal between the at least one tubular conduit and the at least one optical fiber exiting the conduit at the surface.

6. The method for sensing downhole pressure in in a subsurface well of claim 5 wherein the at least one downhole fiber optic gauge is an extrinsic Fabry-Perot (F-P) sensor in series with a Fiber Bragg Grating for temperature compensation.

7. The method for sensing downhole pressure in in a subsurface well of claim 5 further comprising providing a surface vacuum controller system connected to the at least one tubular conduit below the back-end pressure seal.

8. The method for sensing downhole pressure in in a subsurface well of claim 7 wherein the surface pressure control system comprises:
a. a vacuum source;
b. a vacuum gauge for monitoring the pressure in the surface pressure control system; and
c. a vacuum controller system for controlling the operation of the vacuum source.

9. The method for sensing downhole pressure in in a subsurface well of claim 7 further comprising disconnecting the surface vacuum controller system connected to the at least one tubular conduit after a known vacuum is established behind the back-end pressure seal.
